(19) United States
(12) Patent Application Publication
(10) Pub. No.: US 2002/0088691 A1
(43) Pub. Date: Jul. 11, 2002

(54) Flexible screw conveyor with center tensioning core

(76) Inventors: David Hesketh, Rock Hill, SC (US); Michel Podevyn, Grindleton (GB)

Correspondence Address: Adams, Schwartz & Evans, P.A., 2180 Two First Union Center, Charlotte, NC, 28282, US

(21) Appl. No.: 09/957,304

(22) Filed: Sep. 19, 2001

Related U.S. Application Data
(60) Provisional application No. 60/233,700, filed on Sep. 19, 2000.

(51) Int. Cl. B65G 33/26

(52) U.S. Cl. 198/659

(57) ABSTRACT

A flexible screw conveyor includes a center tensioning or tie core that prevents stretching of a spiral screw during operation and reduces clogging of the material being conveyed within the center of the screw. The conveyor has a hollow tube defining an inlet opening for receiving material and an outlet opening for exiting material at opposite ends of the tube. An outlet housing is connected to the tube proximate the outlet opening. An elongate spiral or helical shaped screw is positioned within the tube and extends longitudinally therethrough for conveying material from the inlet opening to the outlet opening. The tensioning core is concentrically positioned within the elongate screw and extends longitudinally therethrough for reducing expansion of the screw by exerting a compressing force on the screw. The tensioning core and the screw are connected to a screw drive within the outlet housing that rotates the screw.

### TECHNICAL FIELD AND BACKGROUND OF THE INVENTION

This patent application claims priority to United States Provisional Patent Application No. 60233700 filed on Sep. 19, 2000. This invention relates to a center tensioning core apparatus and method for a flexible screw conveyor. Such conveyors are specifically suited for transferring powders, dry bulk solids, and other small particulate matter, and typically include a flexible spiral or “screw”. The screw is directly driven by an electric motor, and is completely enclosed and rotates within a flexible outer tube for transferring material from one location to another.

Conventional shaftless flexible screw conveyors provide several advantages. Subject to certain limitations, such conveyors can be installed over, under or around existing machinery. Flexible screw conveyors can also convey in any direction, and can even be installed through small openings in walls. Furthermore, unlike aero mechanical conveyors, which rely upon air as the conveying medium, the screw is the sole conveying medium in many flexible screw conveyors, which protects the materials being conveyed from atmospheric contamination during transfer.

Even though flexible screw conveyors offer many advantages, the components used in constructing such conveyors include a number of inherent limitations. For example, the outer tubes of early prior art flexible screw conveyors have inner diameters as small as two inches, which has resulted in very flexible tubes. Later use of high molecular weight polyethylene in forming prior art conveyor tubes has resulted in stronger tubes having increased diameters. Unfortunately, as the diameter of the outer tube has been increased, the overall flexibility of the tube has been compromised. Specifically, when the inner diameter of the outer tube is three inches or greater, the tube can no longer pass through a ninety-degree bend.

The versatility of a conventional flexible screw conveyor is also limited by the structure of the screw. The screws used in conventional screw conveyors are centerless augers, which are typically fabricated from steel and have either circular, square, or rectangular cross sections. This cross sectional shape limits the ability of the screw to effectively move material through the tube. Because the screw is a centerless auger, the manner in which the screw is positioned within the flexible tube permits the screw to rotate freely therein during operation of the conveyor subject only to the constraints placed upon the screw by the interior of the tube. However, without any central supplemental support, the screw has a tendency to stretch and lengthen, particularly when conveying materials with high densities over long distances. The tendency of the screw to lengthen during operation also makes initial set up of the flexible screw conveyor assembly challenging. Several other variables must also be considered during installation, including the character and density of the product to be conveyed, the layout of the equipment, and the desired length of the conveyor. Given that the screw will almost certainly stretch during operation, it is extremely difficult to accurately determine the appropriate conveyor length and construct a corresponding conveyor assembly that will effectively compensate for the problems inherent in using centerless auger screws.

The invention of the present application overcomes the disadvantages of conventional centerless flexible screw conveyors by providing a flexible screw conveyor having a tensioning or tie core concentrically positioned within and extending along the length of a spiral shaped screw and an outer tube. Using a central tensioning core eliminates several of the problems associated with prior art flexible screw conveyors. Specifically, positioning a tensioning core in the center of the screw prevents materials being conveyed through the tube from collecting in the center of the screw, which in turn reduces stress on the screw and helps prevent the tube from becoming clogged. Using the tensioning core also prevents the screw from stretching lengthwise during operation, thus making the required length of the outer tube and other variables affecting assembly and installation of the conveyor easier to determine.

### SUMMARY OF THE INVENTION

Therefore, it is an object of the invention to provide a flexible screw conveyor which includes a center tensioning core for preventing the screw from stretching during operation and for preventing material being conveyed through the conveyor tube from clogging therein.

It is another object of the invention to provide a flexible screw conveyor having components which are easy to assemble, and whose positions may be easily maintained during operation.

These and other objects of the present invention are achieved in the preferred embodiments disclosed below by providing a screw conveyor apparatus having a hollow tube with openings at opposite ends thereof. A housing is connected to the tube proximate one of the openings, and an elongate spiral or helical shaped screw is positioned within the tube and extends longitudinally therethrough. The elongate screw conveys material through the tube. A tensioning or tie core is concentrically positioned within the elongate screw and extends longitudinally therethrough. The tensioning core prevents expansion of the screw by exerting a restraining force thereon. The tensioning core and the screw are connected to an apparatus contained within the housing that facilitates rotation of the screw.

According to one preferred embodiment of the invention, the conveyor is made of a flexible material.

According to another preferred embodiment of the invention, the tensioning core is a multi-braided steel rope.

According to yet another preferred embodiment of the invention, the tensioning core reduces unwanted collection and compaction of material within the elongate screw.

According to yet another preferred embodiment of the invention, the tube is made of polypropylene.

According to yet another preferred embodiment of the invention, the tube comprises a plurality of interconnected segments.

According to yet another preferred embodiment of the invention, the interconnected segments of the tube are held together by flanges.

According to yet another preferred embodiment of the invention, the conveyor comprises an electric motor, which facilitates rotation of the screw.

According to yet another preferred embodiment of the invention, the screw and the tensioning core are connected to an adaptor positioned within the interior of the housing, and the adaptor is connected to the motor which is mounted to the exterior of the housing.

According to yet another preferred embodiment of the invention, the conveyor includes a hollow tube defining an inlet opening for receiving material and an outlet opening for exiting material at opposite ends of the tube. An outlet housing is connected to the tube proximate the outlet opening. An elongate screw is positioned within the tube and extends longitudinally therethrough for conveying material from the inlet opening to the outlet opening. A tensioning core is concentrically positioned within the elongate screw and extends longitudinally therethrough for preventing expansion of the screw by exerting a restraining force on the screw. The tensioning core and the screw are connected to an apparatus within the outlet housing for enabling rotation of the screw.

According to yet another preferred embodiment of the invention, a hopper is connected to the inlet housing for supplying material to said apparatus.

According to yet another preferred embodiment of the invention, a chute is connected to the outlet housing for allowing material to exit said apparatus.

According to yet another preferred embodiment of the invention, a motor is mounted to the outlet housing.

According to yet another preferred embodiment of the invention, the conveyor includes an inlet housing connected to the tube proximate the inlet opening.

An embodiment of the method of conveying material of the invention, includes the steps of providing a conveyor having a hollow tube defining an inlet opening for receiving material and an outlet opening for exiting material at opposite ends thereof. An outlet housing is connected to the tube proximate the outlet opening. An elongate screw is positioned within the tube and extends therethrough for conveying material from the inlet opening to the outlet opening. A tensioning core is concentrically positioned within the elongate screw and extends therethrough for preventing expansion of the screw by exerting a restraining force thereon. The tensioning core and the screw are connected to means for rotating the screw, which are contained within the outlet housing. The material to be moved is introduced into the inlet housing. The screw is then rotated thereby moving the material out of the inlet housing, through the tube and into the outlet housing. Finally, the material is allowed to exit the outlet housing.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a vertical cross-sectional view of a flexible screw conveyor according to one preferred embodiment of the invention;

FIG. 2 is vertical cross-sectional view of a flexible screw conveyor according to another preferred embodiment of the invention; and

FIG. 3 is an environmental perspective view of a flexible screw conveyor according to yet another preferred embodiment of the invention.

### DESCRIPTION OF THE PREFERRED EMBODIMENT AND BEST MODE

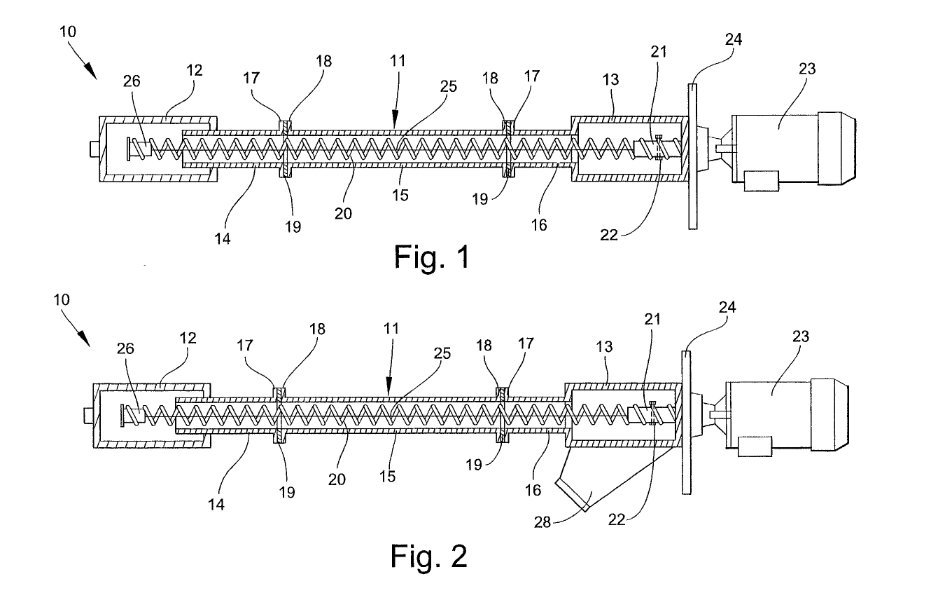

Referring now specifically to the drawings, a flexible screw conveyor according to the present invention is illustrated in FIGS. 1 and 2, and shown generally at reference numeral 10. The conveyor 10 includes a flexible tube 11 which extends between and is connected to an inlet housing 12 and an outlet housing 13 for conveying materials therebetween. Because the tube 11 is preferably formed from high molecular weight polypropylene, the diameter of the tube may be increased. While the conveyor tube shown in FIG. 1 has an outer diameter of 4½″, the outer diameter of the tube may be between 2″ and 8¾″. The tube 11 comprises three segments 14, 15, 16 that are interconnected by inlet flanges 17 and clamp flanges 18. Tube seals 19 are positioned between the inlet flanges 17 and clamp flanges 18. Tube 11 is shown in FIGS. 1 and 2 having a single middle segment 15, however, a plurality of middle segments 15 can be interconnected to obtain a desired length of conveyor 10. Conveyor 10 includes a screw 20 that is flexible and in the shape of an elongate spiral or helix. Screw 20 is positioned within the tube 11 and extends longitudinally therethrough. One end of the screw 20 floats within the interior of the inlet housing 12, and the other end of the screw is connected to a motor/screw adaptor 21 which is positioned inside the outlet housing 13. The screw 20 is held to the adaptor 21 by a screw locator pin 22. The motor/screw adaptor 21 is connected to a motor 23 and permits the motor 23 to communicate with the screw 20 for causing the screw 20 to rotate and move materials through the conveyor 10. In an alternative embodiment, a gearbox can be used in place of the motor 23. The motor 23 is mounted directly to the outlet housing 13 by a mounting bracket 24.

As is shown in FIG. 1, the conveyor 10 includes a tensioning core 25 positioned in the center and extending along the length of both the screw 20 and the conveyor tube 11. One end of the tensioning core 25 is connected to the inlet end of the screw 20, and the other end is connected to the adaptor 21 located inside the outlet housing 13. The tensioning core 25 preferably comprises a multi-braided steel rope, however, it can also be made of a chain, solid bar, tube, wire rope, or other suitable material of construction. Positioning the tensioning core 25 concentrically within the screw 20 and connecting the ends of the screw 20 and tensioning core 25 to a connection sleeve 26 and the adaptor 21 at opposite ends reduces the likelihood that the screw 20 will stretch during operation, and decreases the chance that the material being conveyed will collect and become compacted within the center of the screw 20, which could clog the tube 11. Even if the length of the screw 20 inappropriately increases, the length of the tensioning core 25 may be adjusted so that a compensating compression force is applied to the screw 20.

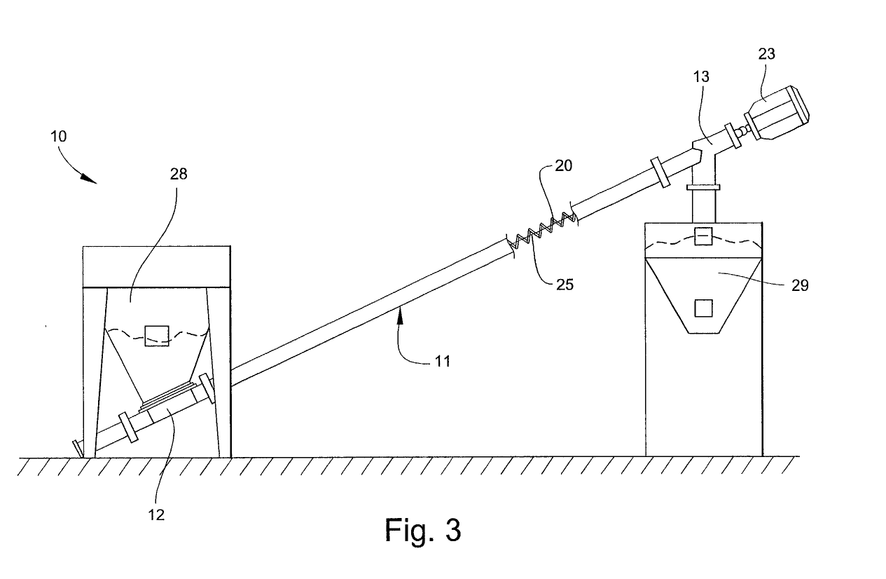

Referring now to FIG. 2, the flexible screw conveyor is shown with an angled outlet chute 27 connected to one side of the outlet housing 13. FIG. 3 shows the flexible screw conveyor 10 with center tensioning core 25 installed in a conventional conveyor assembly for conveying material from a hopper 28 to a single discharge point 29. The flexible screw conveyor 10 with center tensioning core 25 may also be used in other types of flexible conveyor assemblies, including but not limited to those in which: 1) material is conveyed to several discharge points; 2) a horizontal outlet is required; 3) packaging machinery is employed; 4) multiple infeed hoppers are employed; or 5) material is conveyed from a bag-fed hopper to one or multiple discharge points.

A flexible screw conveyor with center tensioning core has been disclosed. Various details of the invention may be changed without departing from its scope. Furthermore, the foregoing description of the preferred embodiments of the invention and the best mode for practicing the invention are provided for the purpose of illustration only and not for the purpose of limitation—the invention being defined by the claims.

We claim:

1. An apparatus for conveying material comprising:
(a) a hollow tube defining openings at opposite ends thereof;
(b) a housing connected to said tube proximate one of said openings;
(c) an elongate spiral screw positioned within said tube and extending therethrough, said screw for conveying material through said tube;
(d) a tensioning core concentrically positioned within said screw and extending therethrough for preventing expansion of said screw by exerting a restraining force thereon; and
(e) a screw drive contained within said housing and connected to said screw and said tensioning core, said screw drive for rotating said screw.

2. The conveyor apparatus of claim 1 wherein said apparatus is comprised of a flexible material.

3. The conveyor apparatus of claim 1 wherein said tensioning core comprises a multi-braided steel rope.

4. The conveyor apparatus of claim 1 wherein said tube comprises polypropylene.

5. The conveyor apparatus of claim 1 wherein said tube comprises a plurality of interconnected tube segments.

6. The conveyor apparatus of claim 5 wherein said interconnected segments are held together by joined flanges.

7. The conveyor apparatus of claim 1 wherein said screw drive comprises an electric motor.

8. The conveyor apparatus of claim 7 wherein said motor is mounted to an exterior of said housing.

9. An apparatus for conveying material comprising:
(a) a hollow tube defining an inlet opening for receiving material and an outlet opening for exiting material, said openings at opposite ends thereof;
(b) an outlet housing connected to said tube proximate said outlet opening;
(c) an elongate spiral screw positioned within said tube and extending therethrough, said screw for conveying material from said inlet opening to said outlet opening;
(d) a tensioning core concentrically positioned within said screw and extending therethrough for preventing expansion of said screw by exerting a restraining force thereon; and
(e) a screw drive contained within said housing and connected to said screw and said tensioning core, said screw drive for rotating said screw.

10. The conveyor apparatus of claim 9 wherein said tube is comprised of a flexible material.

11. The conveyor apparatus of claim 9 wherein said tensioning core comprises a multi-braided steel rope.

12. The conveyor apparatus of claim 9 wherein said tube comprises a plurality of interconnected tube segments.

13. The conveyor apparatus of claim 9 further including a hopper connected to said inlet housing for supplying material to said apparatus.

14. The conveyor apparatus of claim 9 further comprising a chute connected to said outlet housing for allowing material to exit said apparatus.

15. The conveyor apparatus of claim 9 further including an inlet housing connected to said tube proximate said inlet opening.

16. The conveyor apparatus of claim 9 wherein said screw drive comprises an electric motor.

17. The conveyor apparatus of claim 16 wherein said motor is mounted to an exterior of said outlet housing.

18. A method for transporting material comprising the steps of:
(a) providing a conveyor apparatus comprising:
(i) a hollow tube defining an inlet opening for receiving material and an outlet opening for exiting material, said openings at opposite ends thereof;
(ii) an outlet housing connected to said tube proximate said outlet opening;
(iii) an elongate spiral screw positioned within said tube and extending therethrough, said screw for conveying material from said inlet opening to said outlet opening;
(iv) a tensioning core concentrically positioned within said screw and extending therethrough for preventing expansion of said screw by exerting a restraining force thereon; and
(v) a screw drive contained within said housing and connected to said screw and said tensioning core, said screw drive for rotating said screw.
(b) introducing a material into said inlet housing;
(c) rotating said screw to move said material out of said inlet housing, through said tube and into said outlet housing while maintaining a static length of said screw and preventing compaction of material within said screw; and
(d) allowing said material to exit said outlet housing.
